(19) United States
(12) Patent Application Publication
(10) Pub. No.: US 2026/0197186 A1
(43) Pub. Date: Jul. 9, 2026

(54) AUTHENTICATION METHOD, VALIDITY DETERMINATION METHOD, AERIAL VEHICLE CONTROL METHOD, AUTHENTICATION SYSTEM, AND AERIAL VEHICLE CONTROL SYSTEM

(71) Applicant: AERONEXT INC., Tokyo (JP)

(72) Inventors: Seijiro YASUKI, Tokyo (JP); Masanori MORI, Saitama (JP)

(21) Appl. No.: 19/132,376

(22) PCT Filed: Nov. 24, 2023
(86) PCT No.: PCT/JP2023/042151

§ 371 Date: May 23, 2025

(30) Foreign Application Priority Data
Nov. 24, 2022 (JP) 2022-187149

(51) Int. Cl. H04L 9/32

(52) U.S. Cl. CPC H04L 9/3268

(57) ABSTRACT

Provided are an authentication method, a validity determination method, an aerial vehicle control method, an authentication system, and an aerial vehicle control system that enable authentication of drones more conveniently and with higher reliability. The authentication method according to the present disclosure is an authentication method related to authentication of an aerial vehicle performed by one or more information processing devices. The authentication method includes: acquiring type information of the aerial vehicle; determining pass/fail of type authentication based on the type information; encrypting type authentication information regarding type authentication of the aerial vehicle determined to be qualified using a prescribed public key; and transmitting a type authentication passing certificate containing encrypted type information being encrypted along with the prescribed public key to the aerial vehicle to be stored in the aerial vehicle.

### FIELD

The present disclosure relates to an authentication method, a validity determination method, an aerial vehicle control method, an authentication system, and an aerial vehicle control system.

### BACKGROUND

In recent years, autonomous flight performance of drones has become significantly improved due to advances in semiconductor and software technologies. Flight within visual line of sight through manual operations has normally been conducted heretofore, but it is expected that drones flying beyond visual line of sight through autonomous flight will become more common using more sophisticated drones. Such drones are being considered to be applied for various scenes such as for logistics in mountainous areas, remote islands, and the like where it has been difficult to transport goods, spraying agricultural chemicals on large farms, or assessing disaster situations from the air, and inspecting infrastructure that cannot be checked by humans. In such cases, safety considerations during drone flight are extremely important.

In Japan, drone flight control levels are classified into the following four levels, for example.

Level 1 is manual operation, flying within visual line of sight.

Level 2 is autonomous flight, flying within visual line of sight.

Level 3 is autonomous flight, flying over uninhabited areas beyond visual line of sight.

Level 4 is autonomous flight, flying over inhabited areas beyond visual line of sight.

In the above classification, a Level-4 flight certification system is being taken into consideration in order to sufficiently ensure the safety in cases of autonomous flight, and flying over inhabited areas beyond visual line of sight (referred to as Level 4 hereinafter).

Level 4 certification includes (1) authentication of aircraft to ensure the safety of a drone aircraft itself, (2) operation license to certify the skills of the operator, and (3) operational management rules including a flight plan and the like. In addition to that, (4) system design with which owners can be identified is being considered.

In the realization of Level-4 drone flight, (1) authentication of aircraft mentioned above is considered to be particularly important and difficult. The authentication of aircraft consists of “type authentication” for the drone manufacturers and “aircraft authentication” for the drone users. In particular, maintenance is mandatory for the drone users. In the event of a malfunction, there is an obligation to report on the malfunction, and it is expected to perform maintenance in government-registered inspection agencies in response to a maintenance order from the government.

In addition, the certification system includes two kinds that are Class I certification and Class II certification. Class I certification is defined for Level-4 flight, and Class II certification is defined for designated flight other than over third-party airspace. Designated flight herein refers to flying in certain airspace (around airports, in populated areas, and in airspace of 150 m or above) in certain flight methods (at night, beyond line of sight, approaching 30 m or less, and the like), which require application to acquire permission from the Ministry of Land, Infrastructure, Transport and Tourism. More specifically, the type authentication and aircraft authentication are defined as follows.

### (a) Type Authentication

Inspections for makers and manufacturers
Inspections of the design and manufacturing process for each type
Mainly for mass-produced aircrafts
Class I (comply with Level 4), valid for 1 year: inspected by the government
Class II (designated flight other than over third-party airspace), valid for 3 years: initially inspected by the government, then gradually shifted to registered inspection agencies

### (b) Aircraft Authentication

Inspections for drone users
Inspections of the current status of each aircraft
Inspections of the design and manufacturing processes for self-made aircrafts and the like
Class I (comply with Level 4), valid for 1 year: inspected by registered inspection agencies
Class II, valid for 3 years: inspected by registered inspection agencies
For the type-authenticated aircrafts (mainly mass-produced drones), all or part of the inspections performed for each aircraft at the time of aircraft authentication are omitted.

### CITATION LIST

### Non Patent Literature

Non Patent Literature 1: Ministry of Land, Infrastructure, Transport and Tourism, “New System Development for Realization of Level 4 Flight”, [online], Apr. 20, 2022, Ministry of Land, Infrastructure, Transport and Tourism, Internet <URL: https://www.mlit.go.jp/koku/content/001478580.pdf>

### SUMMARY

### Technical Problem

As described above, aircraft authentication is an extremely important system in order to ensure the safety of drones. However, inspections are required at regular intervals, which are costly and time-consuming. As the number of drones owned increases in the future, aircraft authentication will become a significant burden for drone owners and users. In addition, when the number of inspection points and the frequency of inspections increase, there is a higher possibility of having human errors.

The present disclosure therefore provides an authentication method, a validity determination method, an aerial vehicle control method, an authentication system, and an aerial vehicle control system that enable authentication of drones more conveniently and with higher reliability.

### Solution to Problem

According to the present disclosure, provided is an authentication method related to authentication of an aerial vehicle performed by one or more information processing devices, the authentication method including: acquiring type information of the aerial vehicle; determining pass/fail of type authentication based on the type information; encrypting type authentication information regarding type authentication of the aerial vehicle determined to be qualified using a prescribed public key; and transmitting a type authentication passing certificate containing encrypted type information being encrypted along with the prescribed public key to the aerial vehicle to be stored in the aerial vehicle.

According to the present disclosure, also provided is an authentication system related to authentication of an aerial vehicle, the authentication system including a certification authority server and a determination server, in which the determination server: acquires type information of the aerial vehicle via the certification authority server; and determines pass/fail of type authentication based on the type information, and notifies the certification authority server, and the certification authority server: encrypts type authentication information regarding the type authentication of the aerial vehicle determined to be qualified using a prescribed public key; and generates a type authentication passing certificate with the prescribed public key and transmits the type authentication passing certificate to the aerial vehicle.

Other issues and solutions thereof disclosed in the present application will become evident in the “Description of Embodiments” section and in the drawings.

### Advantageous Effects of Invention

According to the present disclosure, authentication of drones can be performed more conveniently and with higher reliability.

### BRIEF DESCRIPTION OF DRAWINGS

FIG. 1 is a diagram illustrating configuration examples of an authentication system 100 and a drone 1000 according to an embodiment.

FIG. 2 is a diagram illustrating configuration examples of a determination server 1400 and the drone 1000 according to the present embodiment.

FIG. 3 is a diagram for describing examples of the configuration and processing of a certification authority server 1100 in type authentication according to the present embodiment.

FIG. 4 is a diagram illustrating examples of configurations and processing of a log collection and analysis server 1300 and the determination server 1400 in aircraft authentication according to the present embodiment.

FIG. 5 is a diagram illustrating examples of the configurations and processing of the certification authority server 1100 and the drone 1000 in aircraft authentication according to the present embodiment.

FIG. 6 is a diagram illustrating examples of the configuration and processing related to the processing to be performed after aircraft authentication of the drone 1000 according to the present embodiment.

FIG. 7 is a flowchart illustrating an example of processing flow of type authentication and aircraft authentication performed by the authentication system 100 according to the present embodiment.

FIG. 8 is a diagram illustrating configurations of an authentication system 110 and a drone 1000 according to a second embodiment of the present disclosure.

FIG. 9 is a diagram illustrating an example of a specific configuration of the authentication system 110 according to the present embodiment.

FIG. 10 is a diagram illustrating an example of a hardware configuration of a communication device 1200 according to the present disclosure.

FIG. 11 is a diagram illustrating an example of a hardware configuration of the certification authority server 1100.

FIG. 12 is a diagram illustrating a configuration example of a drone.

### DESCRIPTION OF EMBODIMENTS

The technology related to an authentication system according to the present disclosure is a technology for enabling type authentication by adding a security-related function to the aircraft of a drone and having it connect to a certification authority server. In addition to that, the present technology may also be a technology for enabling aircraft authentication by connecting the drone to the certification authority server according to operations by the user of the drone or the like via a communication device or the like. According to the authentication system of the present disclosure, it is possible to automate the procedure of aircraft authentication with ensured security. This makes it possible to reduce the burden on the drone user related to authentication procedures. This also makes it possible to execute aircraft authentication of the drone more reliably. In addition, by connecting the aircraft of the drone to a log collection and analysis server via wireless communication means or the like, it is possible to periodically accumulate the status of the aircraft of the drone at the time of flight as log data. By checking such log data as appropriate, it is possible to monitor the status of the drone and maintain the physical condition of the aircraft of the drone.

In Japan, type authentication and aircraft authentication are being considered to be introduced in order to realize Level-4 flight of drones. Type authentication is authentication targeted at manufacturers, in which the design details and manufacturing process are inspected for each type of drones. Meanwhile, aircraft authentication is authentication targeted at drone users, in which the status and the like are inspected for each drone aircraft. An inspection is required every year for Class I certification, while an inspection is required every three years for Class II certification. The type authentication and aircraft authentication are important authentication systems to ensure the safety of drones, but the authentication procedures thereof is burdensome. In particular, aircraft authentication requires periodic inspections for drone users. As the number of drones owned increases in the future, periodic inspections will need to be performed on a large number of drones, which may increase the burden on the drone users. However, it is assumed to have offline authentication with the current aircraft authentication system. This places a heavy burden on the inspector side as well, which may hinder the future spread of Level-4 flight of drones.

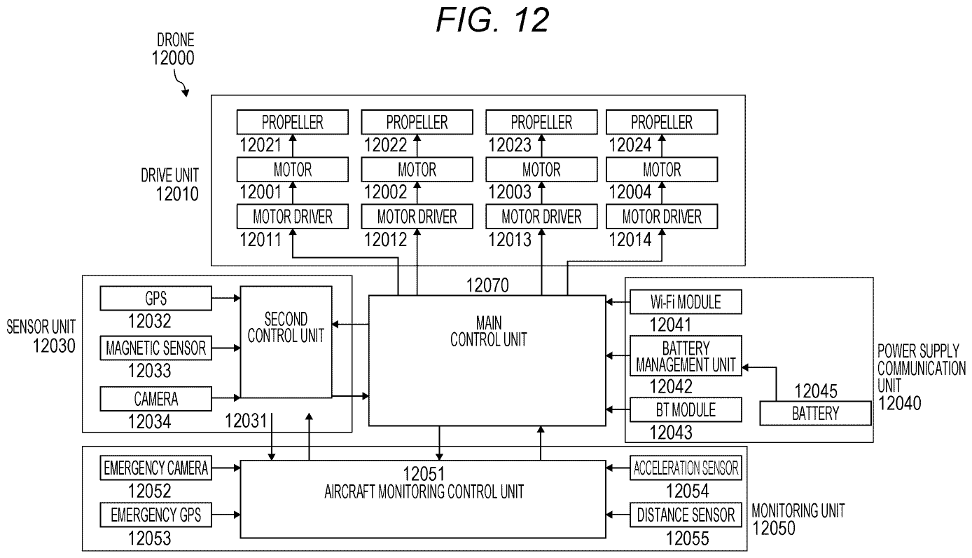

FIG. 12 is a diagram illustrating a configuration example of a drone. A drone 12000 includes a drive unit 12010, a sensor unit 12030, a power supply communication unit 12040, a monitoring unit 12050, and a main control unit 12070.

The drive unit 12010 includes motors 12001 to 12004, motor drivers 12011 to 12014, and propellers 12021 to 12024. The motor drivers 12011 to 12014 are connected to the main control unit 12070. The main control unit 12070 inputs appropriate control signals to the motor drivers 12011 to 12014. The motor drivers 2011 to 12014 control the rotation speed of the corresponding motors 12001 to 12004 in accordance with the control signals. The motors 12001 to 12004 are connected to the propellers 12021 to 12024, respectively, and the rotation of the propellers generates thrust to fly the drone.

The sensor unit 12030 includes a second control unit 12031, a GPS 12032, a magnetic sensor 12033, and a camera 12034. The GPS 12032, which can be realized by the common Global Navigation Satellite System (GNSS), acquires position information of the drone 12000. The GPS 12032 inputs the position information to the second control unit 12031. The magnetic sensor 12033 inputs acquired geomagnetic information to the second control unit 12031. The camera 12034 inputs information of acquired captured images to the second control unit 12031.

The power supply communication unit 12040 includes a Wi-Fi (registered trademark) module 12041, a battery management unit 12042, a Bluetooth (registered trademark) (BT) module 12043, and a battery 12045. The battery management unit 12042 is an information processing device configured with a controller, a memory, and the like, not illustrated. The power acquired from the battery 12045 is supplied by the battery management unit 12042 to each unit as appropriate. The Wi-Fi module 12041 is an example of a communication device with a wireless communication function, and is a module for performing wireless communication with a ground station, not illustrated. Data received via wireless communication is input to the main control unit 12070. The BT module 12043 is connected to the main control unit 12070. The BT module 12043 is used for individual confirmation or the like such as remote ID, for example. Remote ID is already institutionalized in Japan. Specifically, the remote ID is a system that uses Bluetooth beacons or the like for verifying the aircraft number of a drone. Based on the aircraft information periodically output from the BT module 12043, drone individual information can be acquired from a distance.

The monitoring unit 12050 includes an aircraft monitoring control unit 12051, an emergency camera 12052, an emergency GPS 12053, an acceleration sensor 12054, and a distance sensor 12055. The emergency camera 12052 and the emergency GPS 12053 are activated when there is abnormality in the main body of the drone 12000, and input images and position information at the time of the abnormality to the aircraft monitoring control unit 12051, respectively. The acceleration sensor 12054 detects the amount of change in the speed of the drone 12000 (acceleration and angular acceleration), and inputs information on the tilt and orientation of the aircraft to the aircraft monitoring control unit 12051 by the amount of change in the angle of the drone 12000. The distance sensor 12055 detects the distance traveled by the drone 12000 in a certain time, and inputs the detection result to the aircraft monitoring control unit 12051. In the monitoring unit 12050, when a malfunction occurs, the aircraft monitoring control unit 12051 receives an abnormal signal from the main control unit 12070 and controls the drone 12000 to land safely.

As described above, the drone is configured with a large number of components and provided with functions for enabling safe flight, but it is known to become unstable in flight for various reasons. In particular, the motors 12001 to 12004 of the drive unit 12010 prone to have malfunctions rotate at high speeds and are therefore easily overloaded, so it is necessary to check for abnormality in the rotational operation. In addition, malfunctions of the motor drivers 12001 to 12004 cause the motors 12001 to 12004 to stop, which may lead to crashes. As the battery 12045 deteriorates, the capacity thereof decreases and abnormality such as expansion of the battery 12045 itself may occur. Therefore, it is essential to check the capacity and temperature of the battery 12045. Furthermore, in the event of malfunctions in the Wi-Fi module 12041, it is not possible to transmit control signals to the drone 12000. As described above, a drone is configured with a large number of components, and conducting inspections requires a lot of time and effort. Aircraft authentication requires periodic inspections, and as the number of drones increases, the cost of inspections becomes non-negligible.

Therefore, the present disclosure uses digital certificates based on public cryptography as passing certificates for type authentication and aircraft authentication, thereby enabling online authentication procedures. The main body of the drone 12000 is caused to function as a wireless client. A passing certificate is issued to the main body of the drone 12000 by the certification authority server.

As described, the application procedure and certificate issuance can all be done online, thereby making it easier to perform the procedures.

When the expiration date of the passing certificate is over, the drone 12000 may be controlled to stop flight of the drone 12000. In addition, it is possible to perform online revoke processing for stolen drones, and it is even possible to revoke the authentication. It is also possible to determine that the passing certificate is valid by analyzing log data acquired on-time from the drone 12000. This also allows assessment of the physical health of the drone 12000 in real time. Hereinafter, an embodiment of the present disclosure will be described.

An overview of an authentication method according to the present embodiment will be described. First, a drone manufacturer transmits information necessary for type authentication to the certification authority server. Note here that the information necessary for type authentication may include, for example, the results acquired by performing the inspections and the like regarding the design and the manufacturing process of each type based on the regulations defined in advance.

The certification authority server acquires the information necessary for type authentication transmitted from the drone manufacturer, and transmits it to a determination server. The determination server makes determination on the transmitted information necessary for type authentication. The determination server transmits the determination result to the certification authority server.

The certification authority server transmits a type authentication passing certificate to the drone only when it is determined to be qualified, and sets the certificate in the security unit of the drone.

After the main body of the drone is handed over from the drone manufacturer to the drone user, the drone user inputs the information necessary for aircraft authentication into an own communication device.

The information necessary for aircraft authentication is transmitted from the communication device to the certification authority server. The certification authority server transmits the information necessary for aircraft authentication to the determination server, and the determination server determines pass/fail of aircraft authentication.

The determination server transmits the pass/fail result of aircraft authentication to the certification authority server, and the certification authority server transmits a passing certificate of aircraft authentication to the communication device only when certified.

The communication device sets the passing certificate of aircraft authentication in the security unit of the drone.

Through the above-described operation, the passing certificate of type authentication and the passing certificate of aircraft authentication are set in the security unit of the drone.

Next, a case where the drone user flies the drone will be described.

The drone is connected to the log collection and analysis server via a wireless connection, for example. The log collection and analysis server internally accumulates log data (log information) collected during flight standby, flight preparation, and flight of the drone. The log data herein may be, for example, data indicating the status of major components configuring the drone (for example, operation time, abnormal operation status, degradation status, or threshold indicating such status), data output by various kinds of sensors during flight preparation and flight, and image data.

The log data accumulated in the security unit of the drone is transferred from the drone security unit to the log collection and analysis server by periodically communicating with the log collection and analysis server wirelessly, for example. At that time, the log collection and analysis server checks a certificate revocation list for the aircraft authentication listed in the log collection and analysis server. When the certificate of aircraft authentication is being revoked, the log collection and analysis server may invalidate the certificate of aircraft authentication accumulated in the security unit of the drone, for example.

From the second time onward, aircraft authentication is performed by checking the analysis results of log data accumulated on the log collection and analysis server and the passing certificate of aircraft authentication, and then updating the passing certificate of aircraft authentication.

Next, the contents of the present embodiment will be listed and described. While details will be described later, the drone according to the present embodiment includes a sensor unit, a drive unit, a main control unit, a power supply communication unit, a monitoring unit, and a security unit.

The sensor unit includes a GPS, a magnetic sensor, a camera, and a second control unit.

The drive unit includes motor drivers, motors, and propellers.

The power supply communication unit includes a battery, a battery management unit, a Wi-Fi module, and a BT module.

The monitoring unit includes an emergency camera, an emergency GPS, an acceleration sensor, a distance sensor, and an aircraft monitoring control unit.

The security unit includes a communication module, a component DB, a log accumulation DB, an expiration date timer, a digital certificate memory, a root certificate memory, and an operation control unit.

The security unit is connected to each of the certification authority server, the communication device, and the log collection and analysis server, for example, via communication means such as wireless connection via the communication module.

The certification authority server is realized by a computer or server (single or cloud), for example, and has a function of inquiring the determination server about pass/fail of type authentication and, when qualified, transmitting a passing certificate of type authentication to the target drone.

The communication device is realized by, for example, a mobile terminal or the like, and is connected to the drone and the certification authority server. The drone user can use the communication device to input the information necessary for aircraft authentication. The communication device is connected to the certification authority server, and the communication device transmits the information necessary for aircraft authentication to the certification authority server.

The certification authority server inquires the determination unit about pass/fail of aircraft authentication. When qualified, the certification authority server transmits a passing certificate of aircraft authentication to the communication device. The communication device transmits the passing certificate to the drone. The drone authenticates the aircraft authentication passing certificate with the received passing certificate of type authentication. When the authentication is successful, the security unit of the drone can output a signal to the main control unit to enable operation control of the main body.

The drone is connected to the log collection and analysis server. The drone saves the data acquired during flight preparation and during flight in the security unit as log data, and periodically transmits it to the log collection and analysis server via the communication module.

The log collection and analysis server is connected to the certification authority server. The log collection and analysis server stores the certificate revocation list transmitted from the certification authority server. The log collection and analysis server has a function of storing log data transmitted from the drone and collating the aircraft authentication passing certificate of the drone with the certificate revocation list. When the passing certificate is listed in the certificate revocation list, the log collection and analysis server may revoke the passing certificate. The log collection and analysis server also analyzes the stored log data to check for abnormality and, when there is abnormality, may revoke the passing certificate.

### First Embodiment

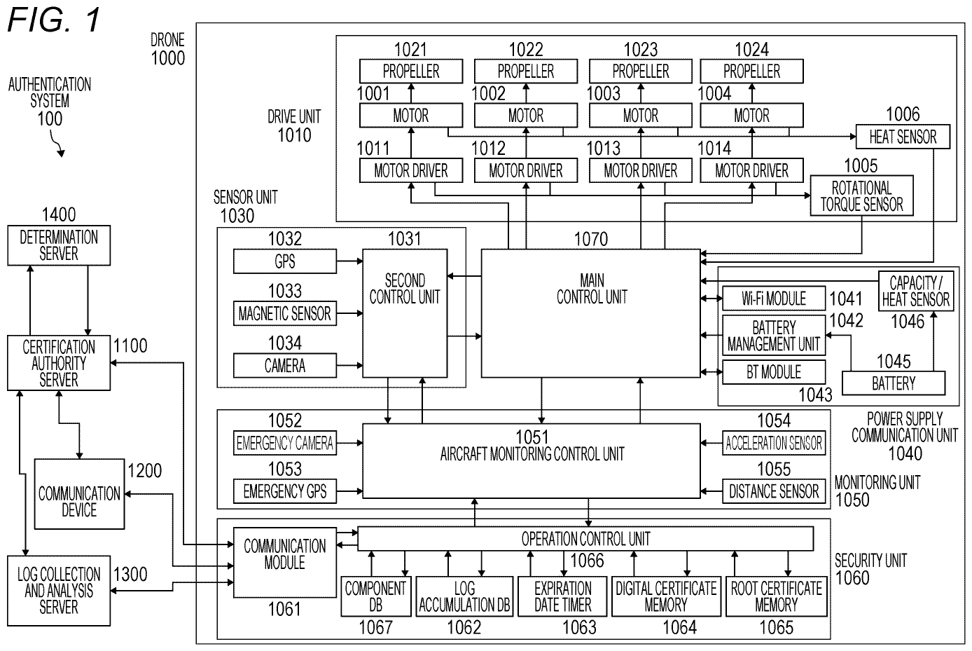

FIG. 1 is a diagram illustrating configuration examples of an authentication system 100 and a drone 1000 according to the present embodiment. As illustrated in FIG. 1, the authentication system 100 includes a certification authority server 1100, a log collection and analysis server 1300, and a determination server 1400. For the drone 1000 as the target of authentication, the authentication system 100 performs type authentication and aircraft authentication. A communication device 1200 may also be used in the authentication system 100.

The drone 1000 includes a drive unit 1010, a sensor unit 1030, a power supply communication unit 1040, a monitoring unit 1050, a security unit 1060, and a main control unit 1070. The functions of the drive unit 1010, sensor unit 1030, power supply communication unit 1040, and monitoring unit 1050 are the same as those of the drone 12000 illustrated in FIG. 12, so the descriptions thereof are omitted.

The security unit 1060 includes a communication module 1061, a log accumulation DB 1062, an expiration date timer 1063, a digital certificate memory 1064, a root certificate memory 1065, an operation control unit 1066, and a component DB 1067. The communication module 1061 is realized by a communication device or the like, for example. The log accumulation DB 1062, the digital certificate memory 1064, the root certificate memory 1065, and the component DB 1067 are the so-called databases, and are realized by memory, storage, and the like. The operation control unit 1066 is realized by information processing functions such as a CPU, GPU, and ASIC performing computing processing, as well as a storage device and the like such as a RAM.

The communication module 1061 can connect to the certification authority server 1100, the communication device 1200, and the log collection and analysis server 1300. Such connections may be implemented through encrypted communication to protect the communication channels from being intercepted by third parties. For encrypted communication, it is possible to use known means such as IPsec and SSL/TLS, for example.

The certification authority server 1100 is connected to the determination server 1400 and conducts certification for type authentication and aircraft authentication. The communication device 1200 is connected to the certification authority server 1100, and performs processing such as communication of information necessary for aircraft authentication and acquisition of a passing certificate of aircraft authentication. The log collection and analysis server 1300 is connected to the certification authority server 1100, and performs accumulation and analysis of log data acquired from the drone 1000 and the like as well as processing of a certificate revocation list.

Hereinafter, operations of the security unit 1060 will be described in detail.

The passing certificate of type authentication is accumulated in the root certificate memory 1065. The passing certificate of type authentication is transmitted from the certification authority server 1100, and input to the operation control unit 1066 through the communication module 1061. The operation control unit 1066 stores the received passing certificate of type authentication in the root certificate memory 1065.

The passing certificate of aircraft authentication is accumulated in the digital certificate memory 1064. The passing certificate of aircraft authentication is, for example, transmitted from the certification authority server 1100, received by the communication device 1200, and transmitted from the communication device 1200 to the communication module 1061. The passing certificate of aircraft authentication is transmitted from the communication module 1061 to the operation control unit 1066, and stored in the digital certificate memory 1064 from the operation control unit 1066.

The expiration date timer 1063 outputs time information to the operation control unit 1066. The operation control unit 1066 compares the acquired time information with the expiration date written on the passing certificate of type authentication accumulated in the root certificate memory 1065 and the expiration date written on the passing certificate of aircraft authentication accumulated in the digital certificate memory 1064 to determine the validity of each of the certificates.

Information on the status of each unit acquired in the drone 1000 is accumulated in the log accumulation DB 1062.

A heat sensor 1006 in the drive unit 1010 is realized by a common thermometer or heat flux sensor, and acquires heat or temperature measurement values of the motors 1001 to 1004. The main control unit 1070 outputs the measurement values acquired from the heat sensor 1006 and information regarding the types of each of the motors to an aircraft monitoring control unit 1051. The aircraft monitoring control unit 1051 may be integrated with the main control unit 1070 or may be realized by a separate information processing device. The aircraft monitoring control unit 1051 outputs the measurement values to the operation control unit 1066. The operation control unit 1066 stores information of the measurement values in the log accumulation DB 1062. The information regarding the types of the motors is input from the aircraft monitoring control unit 1051 to the operation control unit 1066. The operation control unit 1066 stores the information regarding the types in the component DB 1067.

A rotational torque sensor 1005 in the drive unit 1010 acquires the rotational torque values of the motor drivers 1011 to 1014. The main control unit 1070 outputs the measurement values acquired from the rotational torque sensor 1005 and information regarding the types of each of the motor drivers to the aircraft monitoring control unit 1051. The aircraft monitoring control unit 1051 outputs the measurement values of the rotational torque to the operation control unit 1066. The operation control unit 1066 stores the measurement values in the log accumulation DB 1062. The information regarding the types of the motor drivers is input from the aircraft monitoring control unit 1051 to the operation control unit 1066. The operation control unit 1066 stores the information regarding the types in the component DB 1067.

A capacity/heat sensor 1046 in the power supply communication unit 1040 outputs the measurement values of the power capacity and heat of the battery 1045 to the main control unit 1070. The main control unit 1070 outputs the above-described measurement values and information regarding the type of the battery 1045 and the type of the battery management unit 1042 to the aircraft monitoring control unit 1051. The aircraft monitoring control unit 1051 outputs the various kinds of received information to the operation control unit 1066. The operation control unit 1066 stores various kinds of information in the log accumulation DB 1062. Meanwhile, the information regarding the type of the battery and the type of the battery management unit is input from the aircraft monitoring control unit 1051 to the operation control unit 1066. The operation control unit 1066 stores the information regarding the types in the component DB 1067.

A Wi-Fi module 1041 and a BT module 1043 in the power supply communication unit 1040 output communication data to the main control unit 1070. The main control unit 1070 also outputs information regarding the strength of the radio waves received by the Wi-Fi module 1041 and the BT module 1043 to the aircraft monitoring control unit 1051. The aircraft monitoring control unit 1051 outputs the information regarding the strength of the received radio waves to the operation control unit 1066. The operation control unit 1066 stores the information regarding the strength of the received radio waves in the log accumulation DB 1062. Furthermore, information regarding the types of the Wi-Fi module 1041 and the BT module 1043 is input to the operation control unit 1066 via the aircraft monitoring control unit 1051. The operation control unit 1066 stores the information regarding the types in the component DB 1067.

Measurement data acquired from a GPS 1032 and a magnetic sensor 1033 in the sensor unit 1030 is output to the main control unit 1070 via a second control unit 1031. Information regarding the strength of those sensors is also output to the second control unit 1031. The information regarding the strength of the sensors is output from the second control unit 1031 to the aircraft monitoring control unit 1051 via the main control unit 1070. The aircraft monitoring control unit 1051 outputs the measurement data and information regarding the strength of the sensors to the operation control unit 1066. The operation control unit 1066 stores the measurement data and information regarding the strength of the sensors in the log accumulation DB 1062. Information regarding the types of the GPS 1032, the magnetic sensor 1033, and a camera 1034 is also output from the aircraft monitoring control unit 1051 to the operation control unit 1066 via the main control unit 1070, and stored in the component DB 1067.

The measurement data acquired from an acceleration sensor 1054 and a distance sensor 1055 in the monitoring unit 1050 is output to the aircraft monitoring control unit 1051. Information regarding the strength of those sensors is also output to the aircraft monitoring control unit 1051. The aircraft monitoring control unit 1051 outputs the measurement data and information regarding the strength of the sensors to the operation control unit 1066. The operation control unit 1066 stores the measurement data and information regarding the strength of the sensors in the log accumulation DB 1062. Furthermore, information regarding the types of an emergency camera 1052, an emergency GPS 1053, the acceleration sensor 1054, and the distance sensor 1055 is also stored in the component DB 1067 from the operation control unit 1066 via the aircraft monitoring control unit 1051.

The following data is accumulated in the log accumulation DB through the above operations.
Measurement values regarding the heat and temperatures of the motors 1001 to 1004 of the drive unit 1010, and measurement values of the rotational torque of the motor drivers 1011 to 1014
Capacity of the battery 1045 of the power supply communication unit 1040, measurement values of heat and the like regarding the battery 1045, received radio wave strength of the Wi-Fi module 1041, and received radio wave strength of the BT module 1043
Measurement data and sensor strength of the GPS 1032 of the sensor unit 1030, and measurement data and sensor strength of the magnetic sensor 1033
Measurement data and sensor strength of the acceleration sensor 1054 of the monitoring unit 1050, and measurement data and sensor strength of the distance sensor 1055

Acquisition of log data described above is performed continuously or intermittently during flight. The acquired log data is transmitted from the log accumulation DB 1062 to the communication module 1061 via the operation control unit 1066. The communication module 1061 communicates with the log collection and analysis server 1300, and the log data is accumulated in the log collection and analysis server 1300.

In addition, information regarding the types of the motors 1001 to 1004, the types of the motor drivers 1011 to 1014, the type of the battery 1045, the type of the battery management unit 1042, the type of the Wi-Fi module 1041, the type of the BT module 1043, the type of the GPS 1032, the type of the magnetic sensor 1033, the camera 1034, the type of the acceleration sensor 1054, the type of the distance sensor 1055, the type of the emergency camera 1052, and the type of the emergency GPS 1053 is stored in the component DB 1067.

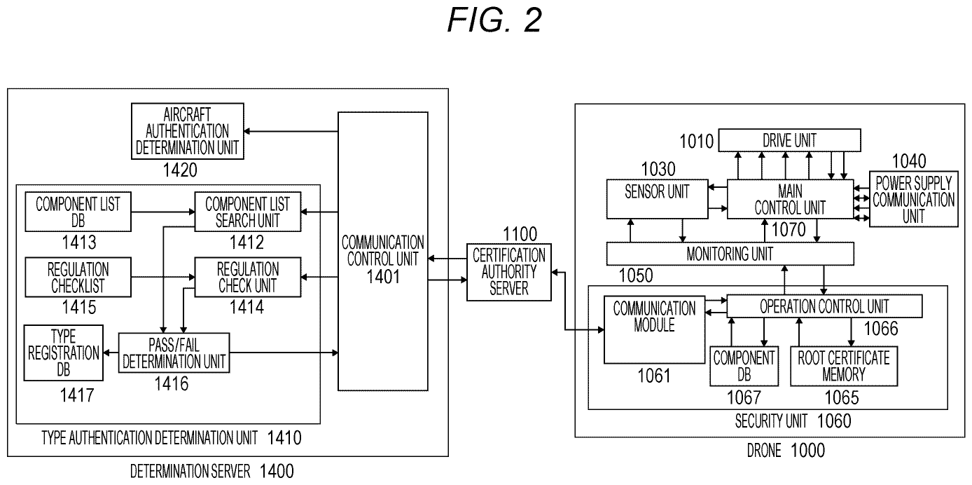

Next, the configuration and processing flow related to the processing of type authentication according to the present embodiment will be described. FIG. 2 is a diagram illustrating configuration examples of the determination server 1400 and the drone 1000 according to the present embodiment.

As illustrated in the drawing, the determination server 1400 includes a communication control unit 1401, a type authentication determination unit 1410, and an aircraft authentication determination unit 1420. In type authentication, the type authentication determination unit 1410 is used. The type authentication determination unit 1410 includes a component list search unit 1412, a component list DB 1413, a regulation check unit 1414, a regulation checklist 1415, a pass/fail determination unit 1416, and a type registration DB 1417.

The communication module 1061 of the security unit 1060 of the drone 1000 is connected to the certification authority server 1100. The certification authority server 1100 is connected to the communication control unit 1401 of the determination server 1400.

The main body type information is written in advance in the root certificate memory 1065. Note here that the main body type information may include the check result regarding the regulation list as well as information such as the model number and serial number of the drone 1000. The main body type information is read out from the root certificate memory 1065 by the operation control unit 1066 and transmitted to the communication module 1061. The communication module 1061 outputs the main body type information to the communication control unit 1401 of the type authentication determination unit 1410 of the determination server 1400 via the certification authority server 1100. The communication control unit 1401 inputs the received main body type information to the regulation check unit 1414. The regulation check unit 1414 checks the regulation checklist of the main body type information based on the information of the regulation list read out from the regulation checklist 1415. If there is no problem in the regulation checklist, the regulation check unit 1414 outputs the passing information to the pass/fail determination unit 1416.

Meanwhile, type information of each unit describing the types of each of the units of the drone 1000 is accumulated in the component DB 1067. Note here that the type information of each unit indicates the type information of each of the main components used in the main body of the drone, which is acquired by the processing described above.

The operation control unit 1066 reads out the type information of each unit from the component DB 1067, and transmits it to the communication module 1061. The communication module 1061 inputs the type information of each unit into the component list search unit 1412 of the type authentication determination unit 1410 of the determination server 1400 via the certification authority server 1100. The component list search unit 1412 reads out information of each unit in the type information of each unit and information regarding the components from the component list DB 1413, and checks whether the components corresponding to the type information of each unit is registered in the component list DB 1413. Note here that a list of components specified by the regulations is written in the component list DB 1413. The component list search unit 1412 checks whether the information of each unit of the drone 1000 in the type information of each unit matches the components registered according to the regulations, and if so, it outputs passing information to the pass/fail determination unit 1416.

When the passing information is input from both of the regulation check unit 1414 and component list search unit 1412, the pass/fail determination unit 1416 outputs the passing information indicating that the type authentication is certified to the communication control unit 1401. The communication control unit 1401 outputs the passing information to the certification authority server 1100. Furthermore, the pass/fail determination unit 1416 registers the type information indicating the drone main body in the main body type information output from the regulation check unit 1414 to the type registration DB 1417. The type information registered herein is used for confirming that it is a certified drone at the time of aircraft authentication.

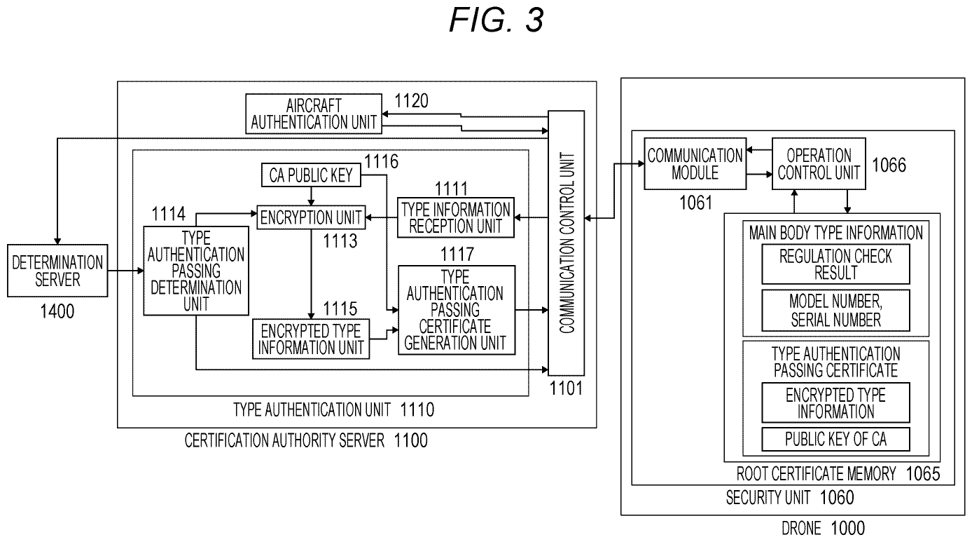

Next, the configuration and processing of the certification authority server 1100 in type authentication according to the present embodiment will be described. FIG. 3 is a diagram for describing examples of the configuration and processing of the certification authority server 1100 in type authentication according to the present embodiment. Here, the configurations and processing of the security unit 1060 of the drone 1000 and the certification authority server 1100 related to type authentication will mainly be described.

As illustrated in the drawing, the certification authority server 1100 includes a communication control unit 1101, a type authentication unit 1110, and an aircraft authentication unit 1120. For the processing of type authentication, the type authentication unit 1110 of the certification authority server 1100 is used. The type authentication unit 1110 includes a type information reception unit 1111, an encryption unit 1113, a type authentication passing determination unit 1114, an encrypted type information unit 1115, a CA public key 1116, and a type authentication passing certificate generation unit 1117. It is assumed herein that the main body type information is saved in advance in the root certificate memory 1065 of the security unit 1060 of the drone 1000.

The saved main body type information may include, as the case described above, the check result of the regulation list as well as information such as the model number and serial number of the drone main body. The check result of the regulation list may include, for example, the result acquired by inspections of the drone performed by the drone manufacturer or an inspector based on the regulations defined in advance.

The operation control unit 1066 reads out the main body type information from the root certificate memory 1065, and transmits it to the communication control unit 1101 of the certification authority server 1100 via the communication module 1061. The communication control unit 1101 transmits the main body type information to the type information reception unit 1111. The type information reception unit 1111 acquires information regarding the model number and serial number of the drone main body from the main body type information, and adds information regarding the validity date and the issuer to create type information in plain text. The type information in plain text is encrypted by the encryption unit 1113 with the CA public key 1116. The type information being encrypted (referred to as encrypted type information) is output to the encrypted type information unit 1115.

The encrypted type information unit 1115 outputs the encrypted type information to the type authentication passing certificate generation unit 1117. The type authentication passing certificate generation unit 1117 generates a type authentication passing certificate by combining the CA public key 1116 and the encrypted type information, and outputs the type authentication passing certificate to the communication control unit 1101. Here, when passing information is transmitted from the type authentication passing determination unit 1114 to the communication control unit 1101, the communication control unit 1101 transmits the type authentication passing certificate to the communication module 1061, and it is saved in the root certificate memory 1065 via the operation control unit 1066. When passing information is not transmitted from the type authentication passing determination unit 1114 to the communication control unit 1101, the communication control unit 1101 transmits a failure notice to the communication module 1061, and stops further processing by the operation control unit 1066. Note here that the type authentication passing determination unit 1114 determines pass/fail based on the passing information transmitted from the determination server 1400.

When type authentication through the processing described above is successful, a type authentication passing certificate is saved in the root certificate memory 1065 of the security unit 1060 of the drone 1000. The type authentication passing certificate is configured with the encrypted type information and the CA public key. Encrypted type information includes the information regarding the model number and serial number of the drone main body, the validity date, and the issuer, which are encrypted.

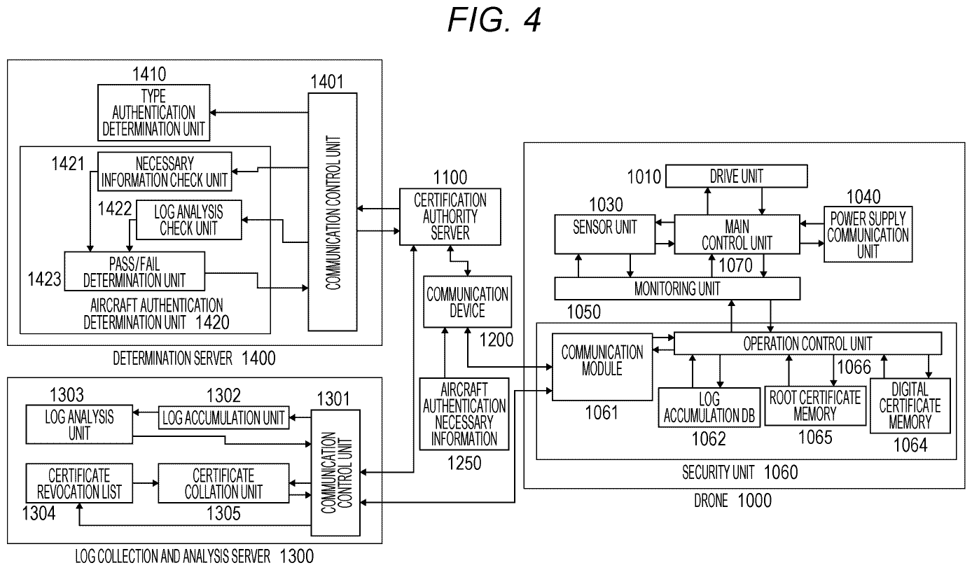

Next, processing of aircraft authentication according to the present embodiment will be described. FIG. 4 is a diagram illustrating examples of configurations and processing of the log collection and analysis server 1300 and the determination server 1400 in aircraft authentication according to the present embodiment. Note that only the part of the security unit 1060 used for determining aircraft authentication is illustrated In FIG. 4, and the component DB 1067 and the expiration date timer 1063 are omitted.

The determination server 1400 includes the communication control unit 1401, the type authentication determination unit 1410, and the aircraft authentication determination unit 1420. The aircraft authentication determination unit 1420 includes a necessary information check unit 1421, a log analysis check unit 1422, and a pass/fail determination unit 1423. For aircraft authentication, the aircraft authentication determination unit 1420 is used.

The log collection and analysis server 1300 includes a communication control unit 1301, a log accumulation unit 1302, a log analysis unit 1303, a certificate revocation list 1304, and a certificate collation unit 1305.

The determination server 1400 makes determination on aircraft authentication based on the necessary information input by the drone user, the log analysis result, and information regarding revocation of the certificate.

### (1) Determination Related to Necessary Information

The operation control unit 1066 acquires the encrypted type information of the type authentication passing certificate from the root certificate memory 1065, and transmits it to the communication module 1061. The communication module 1061 transmits the encrypted type information to the communication device 1200. The drone user inputs aircraft authentication necessary information, which is the information necessary for aircraft authentication, to the communication device 1200. The communication device 1200 then transmits the input aircraft authentication necessary information to the certification authority server 1100 along with the encrypted type information. Note here that the aircraft authentication necessary information includes information that enables identification of the user, such as the name, address, and license information regarding drone operations related to the drone user.

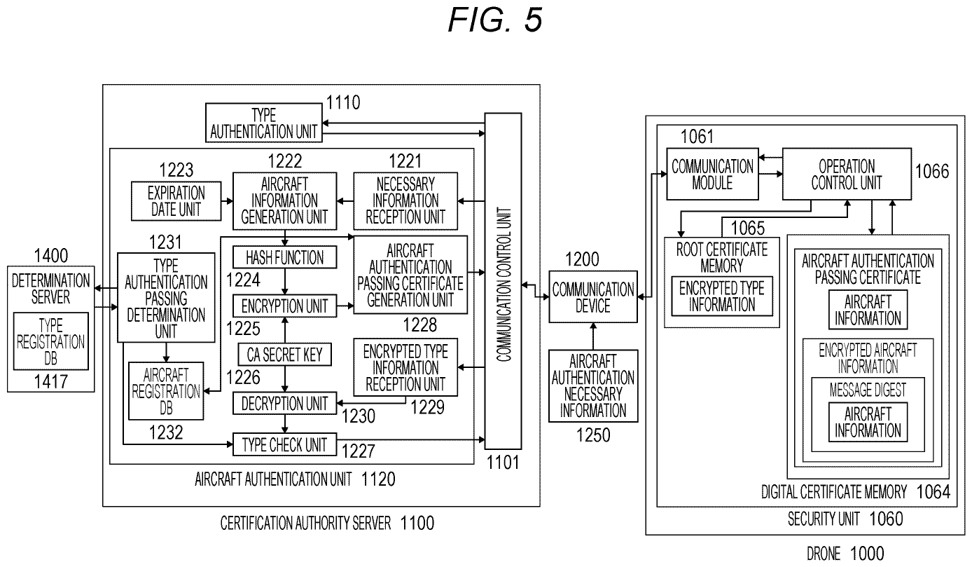

The certification authority server 1100 first transmits the aircraft authentication necessary information to the determination server 1400. Note that the encrypted type information is not used by the determination server 1400, but is used in the aircraft authentication processing performed in the certification authority server 1100 illustrated in FIG. 5 to be described later. The determination server 1400 receives the aircraft authentication necessary information, and transmits it to the necessary information check unit 1421. The necessary information check unit 1421 checks the aircraft authentication necessary information and determines whether the information is appropriate. The appropriateness of information is determined by checking whether information necessary for the aircraft authentication processing is included therein, such as whether the attributes and contents of the input information match and whether there are any omissions, for example. When the aircraft authentication necessary information is appropriate, the necessary information check unit 1421 transmits passing information to the pass/fail determination unit 1423.

### (2) Determination Related to Log Analysis

The log information accumulated in the log accumulation DB 1062 is acquired by the operation control unit 1066 and transmitted to the communication module 1061. The communication module 1061 is connected to the log collection and analysis server 1300, and the log information is transmitted to the communication control unit 1301 of the log collection and analysis server 1300. The communication control unit 1301 transmits the log information to the log accumulation unit 1302. The log information accumulated in the log accumulation unit 1302 is acquired by the log analysis unit 1303. The log analysis unit 1303 performs log analysis to check for abnormality in the log information. Whether there is abnormality in the log information is checked, for example, by performing analysis on whether there are any errors, outliers, and the like in the log information. The log analysis unit 1303 transmits the log analysis result to the communication control unit 1301. The communication control unit 1301 transmits the log analysis result to the communication control unit 1401 of the determination server 1400 via the certification authority server 1100. The communication control unit 1401 outputs the log analysis result to the log analysis check unit 1422. The log analysis check unit 1422 checks whether there is abnormality in the log analysis result, and when there is no abnormality, outputs passing information to the pass/fail determination unit 1423.

### (3) Determination Related to Certificate Revocation List

The certificate revocation list 1304 holds a list of revoked aircraft authentication passing certificates. The operation control unit 1066 acquires the aircraft authentication passing certificate saved in the digital certificate memory 1064, and outputs it to the communication module 1061. The communication module 1061 transmits the aircraft authentication passing certificate to the communication control unit 1301. The communication control unit 1301 outputs the aircraft authentication passing certificate to the certificate collation unit 1305. The certificate collation unit 1305 collates the acquired aircraft authentication passing certificate with the revoked aircraft authentication passing certificates included in the certificate revocation list 1304. When the aircraft authentication passing certificate of the drone 1000 is found to be revoked as a result of the collation, the certificate collation unit 1305 transmits revocation information of the aircraft authentication passing certificate to the certification authority server 1100 via the communication control unit 1301. Upon receiving the revocation information of the aircraft authentication passing certificate, the certification authority server 1100 performs revocation processing for the aircraft authentication passing certificate.

FIG. 5 is a diagram illustrating examples of the configurations and processing of the certification authority server 1100 and the drone 1000 according to the present embodiment. The certification authority server 1100 includes the communication control unit 1101, the type authentication unit 1110, and the aircraft authentication unit 1120. The aircraft authentication unit 1120 includes a necessary information reception unit 1221, an aircraft information generation unit 1222, an expiration date unit 1223, a hash function 1224, an encryption unit 1225, a CA secret key 1226, a type check unit 1227, an aircraft authentication passing certificate generation unit 1228, an encrypted type information reception unit 1229, a decryption unit 1230, a type authentication passing determination unit 1231, and an aircraft registration DB 1232.

As illustrated in the drawing, the drone user first inputs aircraft authentication necessary information 1250 using the communication device 1200. The aircraft authentication necessary information 1250 is transmitted from the communication device 1200 to the communication control unit 1101 of the certification authority server 1100. The aircraft authentication necessary information 1250 is output to the necessary information reception unit 1221. The necessary information reception unit 1221 adds the information on the type certificate issuer to the aircraft authentication necessary information 1250, and outputs the aircraft authentication necessary information 1250 to the aircraft information generation unit 1222.

The aircraft information generation unit 1222 generates aircraft information by combining the expiration date information output from the expiration date unit 1223 with the aircraft authentication necessary information. The aircraft information is output to the hash function 1224, the aircraft authentication passing certificate generation unit 1228, and the aircraft registration DB 1232. The aircraft registration DB 1232 registers the aircraft information, when the passing information is output by the type authentication passing determination unit 1231. Note here that the aircraft information may include, as described above, information that enables identification of the user, such as the name, address, and license information regarding drone operations related to the drone user, as well as information on the type certificate issuer, and expiration date.

Then, the aircraft information output from the aircraft information generation unit 1222 is converted into a message digest by the hash function 1224. The converted message digest is encrypted in the encryption unit 1225 using the CA secret key 1226. The encrypted message digest is output to the aircraft authentication passing certificate generation unit 1228. The aircraft authentication passing certificate generation unit 1228 combines the encrypted message digest and the aircraft information to create an aircraft authentication passing certificate, and outputs it to the communication control unit 1101.

Next, the operation control unit 1066 acquires the encrypted type information included in the type authentication passing certificate from the root certificate memory 1065. The encrypted type information is output from the communication module 1601 to the communication control unit 1101 of the certification authority server 1100 via the operation control unit 1066. The encrypted type information is input to the encrypted type information reception unit 1229. The encrypted type information is then decrypted by the decryption unit 1230 using the CA secret key 1226 and converted to type information in plain text.

The type authentication passing determination unit 1231 acquires the type information included in the type registration DB 1417 in the determination server 1400, and transmits it to the type check unit 1227. The type check unit 1227 compares the type information output from the decryption unit 1230 with the type information acquired from the type authentication passing determination unit 1231 to determine whether it is already-registered type information. When it is determined to be already-registered type information, the type check unit 1227 outputs passing information to the communication control unit 1101. When the type information does not exist, transmission of the aircraft authentication passing certificate to the communication control unit 1101 is stopped.

Upon acquiring the passing information, the communication control unit 1101 transmits the aircraft authentication passing certificate to the communication module 1061 in the security unit 1060 of the drone 1000 via the communication device 1200. Note that the communication control unit 1101 may transmit the aircraft authentication passing certificate directly to the communication module 1061 of the drone 1000. The communication module 1061 saves the received aircraft authentication passing certificate in the digital certificate memory 1064 via the operation control unit 1066. As illustrated in FIG. 5, the aircraft authentication passing certificate is stored in the digital certificate memory 1064. The stored aircraft authentication passing certificate may include, along with aircraft information in plain text, encrypted aircraft information that is obtained by encrypting the message digest of the aircraft information.

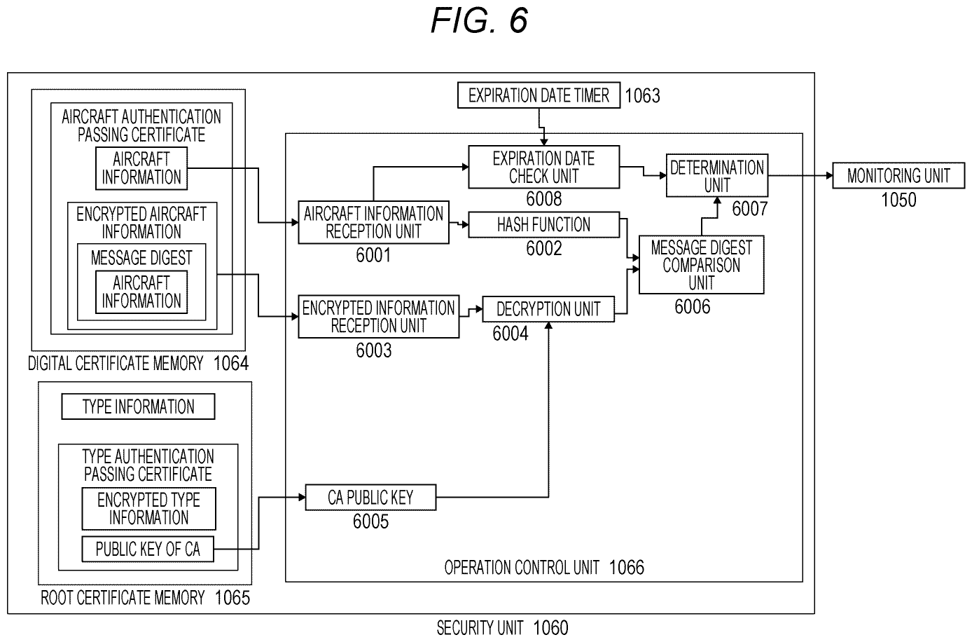

Next, processing in the drone 1000 performed after completing aircraft authentication will be described. FIG. 6 is a diagram illustrating examples of configuration and processing related to the processing performed after aircraft authentication of the drone 1000 according to the present embodiment. As illustrated in the drawing, the operation control unit 1066 of the security unit 1060 includes an aircraft information reception unit 6001, a hash function 6002, an encrypted information reception unit 6003, a decryption unit 6004, a CA public key 6005, a message digest comparison unit 6006, a determination unit 6007, and an expiration date check unit 6008.

When type authentication and aircraft authentication of the drone 1000 are completed, an aircraft authentication passing certificate is saved in the digital certificate memory 1064 of the security unit 1060, and type information and a type authentication passing certificate are saved in the root certificate memory 1065. With those certificates, the security unit 1060 of the drone 1000 can determine whether flight operations of the drone 1000 are possible.

First, the operation control unit 1066 acquires aircraft information and the encrypted aircraft information included in the aircraft authentication passing certificate from the digital certificate memory 1064. Meanwhile, the operation control unit 1066 acquires the CA public key from the root certificate memory 1065. Here, the acquired aircraft information is acquired by the aircraft information reception unit 6001 in the operation control unit 1066, and converted into a message digest using the hash function 6002. Meanwhile, the encrypted information acquired from the digital certificate memory 1064 is acquired by the encrypted information reception unit 6003 in the operation control unit 1066, and decrypted by the decryption unit 6004 using the CA public key 6005.

The decrypted message digest is input to the message digest comparison unit 6006. The message digest comparison unit 6006 then compares the decrypted message digest with the message digest output from the hash function 6002. When those message digests match, it is determined that the aircraft authentication passing certificate is valid. In this case, the message digest comparison unit 6006 outputs a match signal to the determination unit 6007.

Furthermore, the aircraft information reception unit 6001 acquires information of the expiration date included in the aircraft information, and outputs it to the expiration date check unit 6008. The expiration date check unit 6008 makes comparison with the value of the expiration date indicated by the expiration date timer 1063 to check whether the expiration date included in the aircraft information is not over. When the expiration date is confirmed, the expiration date check unit 6008 outputs a confirmation signal to the determination unit 6007. Upon acquiring the output of the expiration date check unit 6008 and the output of the message digest comparison unit 6006, and when those are satisfied at the same time, the determination unit 6007 determines that the aircraft authentication passing certificate is valid and outputs an operation ready signal. The operation ready signal is output to the monitoring unit 1050. By acquiring such an operation ready signal, control regarding flight and the like of the drone 1000 can be performed as usual. Meanwhile, when the operation ready signal is not output from the determination unit 6007, the drone 1000 is disabled for flight. When the drone 1000 is in flight, the drone 1000 is landed.

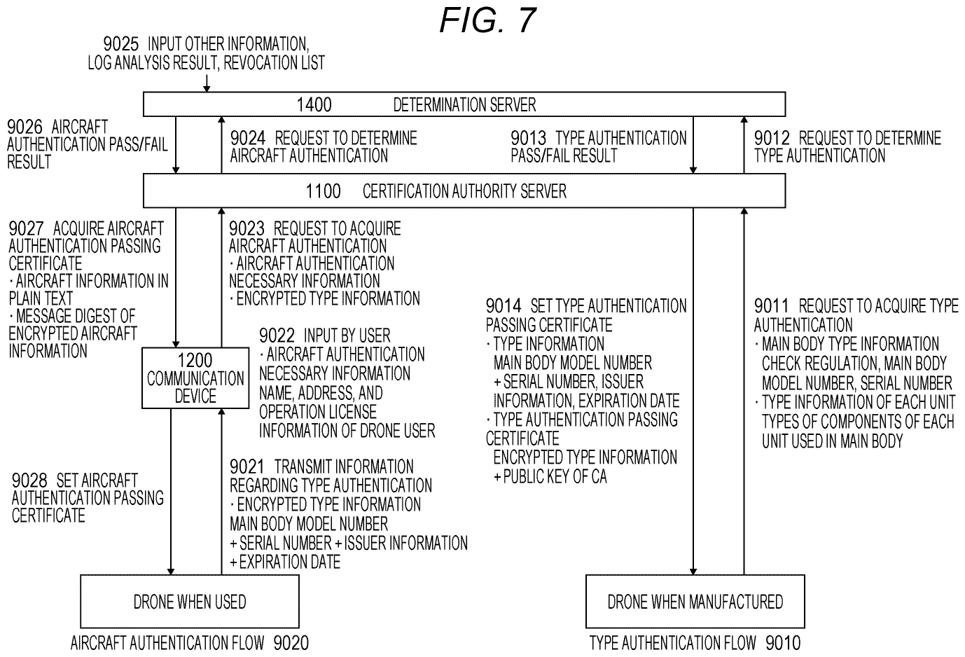

FIG. 7 is a flowchart illustrating an example of processing flow of type authentication and aircraft authentication performed by the authentication system 100 according to the present embodiment. First, a type authentication processing flow 9010 will be described. For type authentication, the manufacturer conducts the procedure before delivery to the user. The manufacturer manufactures the drone by following the regulations defined in advance. In the regulations, for example, the components that can be used, manufacturing steps, and operational test procedures, and the like are defined. The manufacturer checks the items of the regulations and makes a request for acquiring type authentication from the drone 1000 to the certification authority server 1100 by communication.

In a type authentication acquisition request phase 9011, for the drone at the time of manufacture, a regulation check list for type authentication as well as the model number of the main body and serial number are recorded on the main body as the main body type information. In addition, the type information of each unit, which is information of the components configuring the drone, is also recorded on the main body. The type information of each unit is a list of components used in the main body of the drone, and is used to check whether the components specified in the regulations are used properly.

Then, in a type authentication determination request phase 9012, the certification authority server 1100 transmits the main body type information and type information of each unit to the determination server 1400 to request determination.

In a type authentication pass/fail result phase 9013, the determination server 1400 returns a type authentication pass/fail result to the certification authority server 1100 as passing information.

In a type authentication passing certificate setting phase 9014, the certification authority server 1100 sets the type authentication passing certificate to the drone 1000. The type information includes the model number of the main body, serial number, issuer information, and expiration date, and the type information is encrypted. The encrypted type information and the CA public key of the certification authority server 1100 configure the type authentication passing certificate, which is recorded on the drone 1000 at the time of manufacture.

Next, an aircraft authentication flow 9020 will be described. For aircraft authentication, the drone user carries out the procedure. The drone user, for example, uses the communication device 1200 for setting up.

First, in a type-authentication related information transmission phase 9021, the encrypted type information stored in the drone 1000 is transmitted to the communication device 1200. The encrypted type information includes, for example, the model number of the main body, serial number, issuer information, and expiration date.

In a user input phase 9022, the drone user, after acquiring the encrypted type information, inputs the information necessary for aircraft authentication to the communication device 1200. The aircraft information necessary information may include, for example, information that can identify the user, such as the name, address, and operation license information of the drone user.

In an aircraft authentication acquisition request phase 9023, the drone user makes a request to the certification authority server 1100 to acquire aircraft authentication by the communication device 1200. Specifically, the aircraft authentication necessary information and the encrypted type information are transmitted from the communication device 1200 to the certification authority server 1100.

In an aircraft authentication determination request phase 9024, the certification authority server 1100 transmits the aircraft authentication necessary information to the determination server 1400 to request determination. In parallel, the encrypted type information is decrypted in the certification authority server 1100 to check the contents of the type information.

In other information input phase 9025, the log analysis result and the revocation list are input as auxiliary information to the determination server 1400 from outside. Note that such processing may be performed by an authentication system 110 according to a second embodiment described later.

In an aircraft authentication pass/fail result phase 9026, the determination server 1400 transmits a pass/fail determination result (passing information) of aircraft authentication to the certification authority server 1100.

In an aircraft authentication passing certificate acquisition phase 9027, the certification authority server 1100 transmits an aircraft authentication passing certificate to the communication device 1200. Note here that the aircraft information in plain text and the encrypted message digest of the aircraft are written in the aircraft authentication passing certificate.

Then, in an aircraft authentication passing certificate setting phase 9028, the aircraft authentication passing certificate is transmitted from the communication device 1200 to the drone 1000 that is the target of aircraft authentication. The drone 1000 stores the aircraft authentication passing certificate.

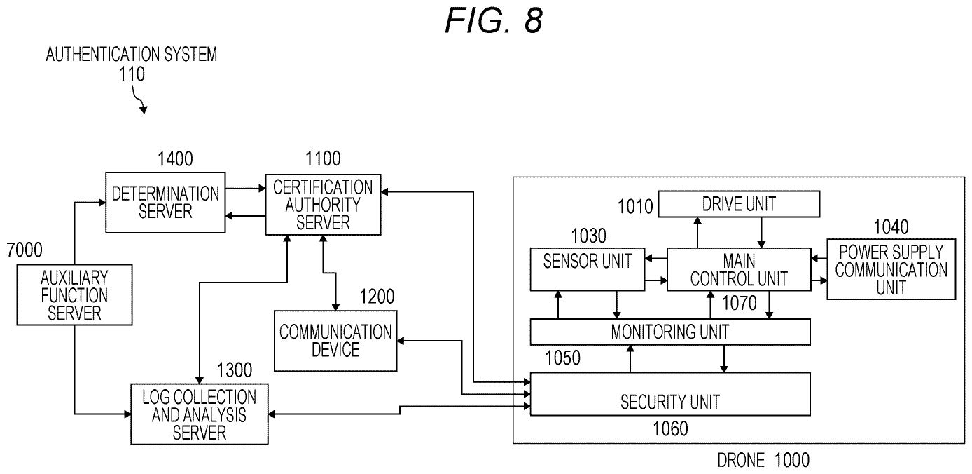

Next, the second embodiment of the present disclosure will be described. FIG. 8 is a diagram illustrating configurations of the authentication system 110 and the drone 1000 according to the second embodiment of the present disclosure. The configuration of the drone 1000 is the same as that of the first embodiment, so the description thereof will be omitted.

The authentication system 110 according to the present embodiment is configured by further adding an auxiliary function server 7000 to the authentication system 100 of the first embodiment. The auxiliary function server 7000 is connected to the certification authority server 1100 and the determination server 1400.

In the first embodiment according to the present disclosure, aircraft authentication is executed after executing type authentication. Determination on whether to qualify type authentication can be implemented by transmitting the regulation checklist and component list written in advance in the security unit 1060 to the determination server 1400 via the certification authority server 1100.

Next, aircraft authentication is performed by checking the type information acquired through type authentication in the certification authority server 1100 and by checking the aircraft authentication necessary information, the log analysis result, and the certificate revocation list in the determination server 1400.

In the present embodiment, the use of the auxiliary function server 7000 can improve the accuracy of log analysis and certificate revocation list check performed in aircraft authentication.

Specifically, the log analysis according to the present embodiment uses auxiliary information that is based on manual inspections by an inspector or the like as log data, in addition to sensor information gathered from each unit of the drone 1000. The drone has externally visible propellers, airframe, connectors, cables, and the like, and those components are directly affected by the external environment. Thus, log data acquired from the sensors and the like alone may not fully reflect the status of the aircraft. Therefore, in the present embodiment, in addition to the log data from the sensors and the like, visual data acquired by the inspector through visual inspections is added as auxiliary data for the log data, thereby further improving the accuracy in aircraft authentication.

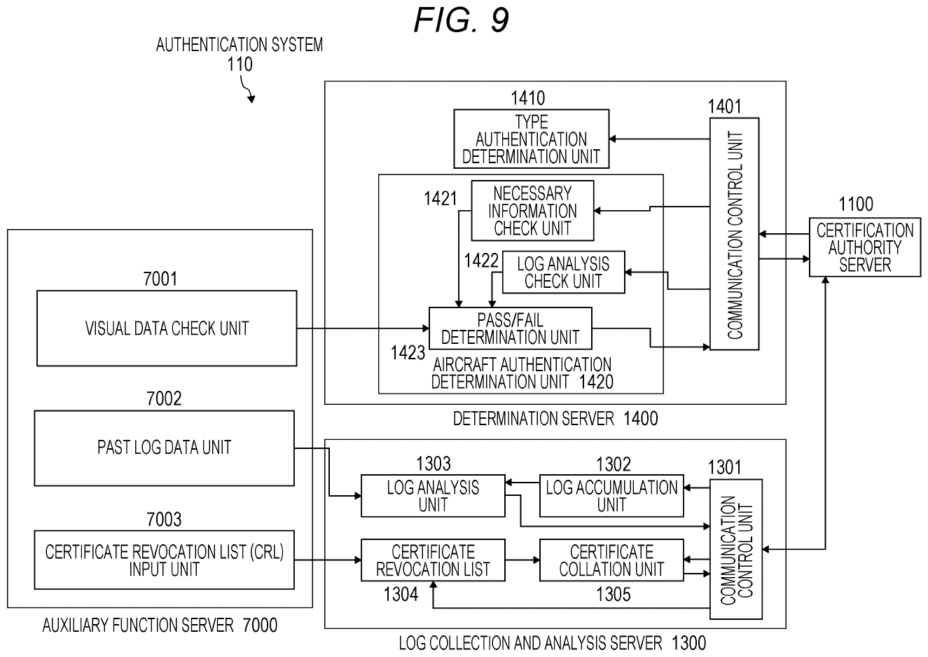

FIG. 9 is a diagram illustrating an example of a specific configuration of the authentication system 110 according to the present embodiment. As illustrated in FIG. 9, the auxiliary function server 7000 includes a visual data check unit 7001, a past log data unit 7002, and a certificate revocation list (CRL) input unit 7003.

The visual data check unit 7001 saves inspection data that is acquired by inspections performed by the inspector. The visual data check unit 7001 is connected, for example, to the pass/fail determination unit 1423 in the aircraft authentication determination unit 1420 of the determination server 1400. When check information reflecting obvious damage, distortion, or the like is included in the visual data check unit 7001, and when such check information is output to the pass/fail determination unit 1423, the pass/fail determination unit 1423 can avoid outputting passing information. Through the above-described processing, it is possible to add information that cannot be supplemented by the sensor information gathered from each unit of the drone 1000 and improve the accuracy in making pass/fail determination.

The log collection and analysis server 1300 saves log data indicating the status of the drone during flight. The accuracy of the log data analysis can be improved by using log data of other drones of the same type and components of the same type. The past log data unit 7002 is connected to the log analysis unit 1303 of the log collection and analysis server 1300. By increasing the number of pieces of data through adding the past log data of the drones and components of the same type to the log analysis unit 1303, the accuracy of the log data analysis is improved.

The certificate revocation list (CRL) input unit 7003 is provided to be connectable to the certificate revocation list 1304 of the log collection and analysis server 1300. For the aircraft that has been stolen or has major malfunctions, flight of the drone can be restricted by issuing the certificate revocation list. Normally, a certificate revocation list that can be acquired over the network is monitored and registered in the certificate revocation list 1304. However, in the present embodiment, the CRL input unit 7003 can acquire the certificate revocation list, and update the certificate revocation list 1304 on which a theft report and defect report according to such a list are reflected. Furthermore, when there is a report to revoke a certificate, the CRL input unit 7003 immediately outputs the latest certificate revocation list to the certificate revocation list 1304. This allows the flight operation of a problematic drone to be stopped more quickly.

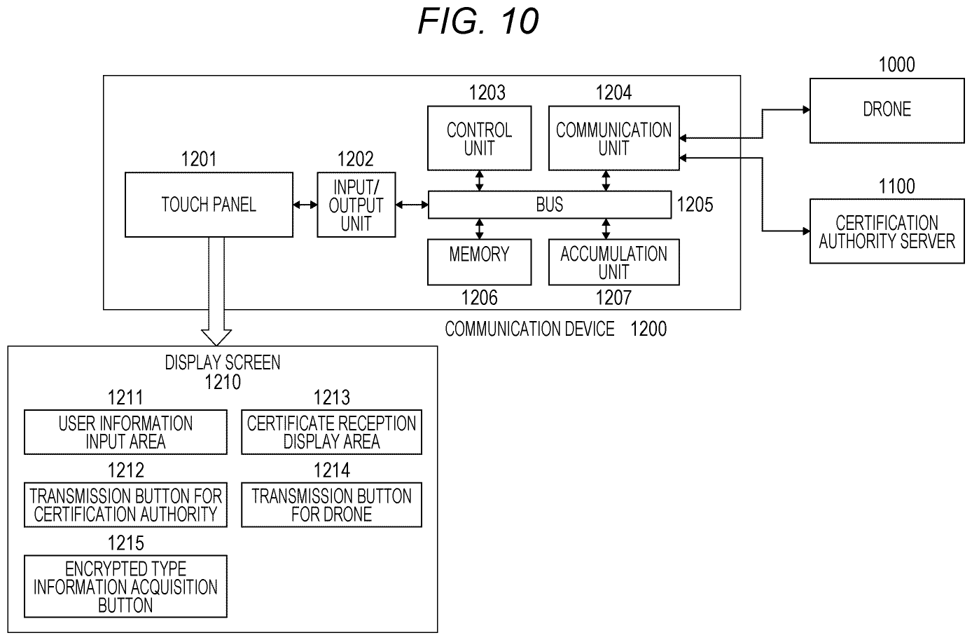

FIG. 10 is a diagram illustrating an example of a hardware configuration of the communication device 1200 according to the present disclosure. As illustrated in the drawing, the communication device 1200 includes a touch panel 1201, an input/output unit 1202, a CPU 1203, a communication unit 1204, a bus 1205, a memory 1206, and an accumulation unit 1207. The touch panel 1201 may be, for example, a general touch panel such as a piezoelectric or capacitive type. The input/output unit 1202 may be realized by a display, other interface devices, or the like. The CPU 1203 is realized by a microprocessor, for example. The CPU 1203 is not limited to a CPU, but may also be a processor such as an ASIC. The communication unit 1204 is a device for communicating with external devices by wired or wireless communication. The bus 1205 is a component that realizes a communication function with each functional unit of the communication device 1200. The memory 1206 is a device that realizes a short-term storage function such as a RAM and cache. The accumulation unit 1207 may be a hardware storage such as an SSD, flash, or the like.

The communication device 1200 is configured to be connectable to the drone 1000 and the certification authority server 1100 via the communication unit 1204.

The touch panel 1201 can display a display screen 1210 as illustrated in the drawing, for example. For example, the display screen 1210 may include a user information input area 1211, a transmission button for certification authority 1212, a certificate reception display area 1213, a transmission button for drone 1214, and an encrypted type information acquisition button 1215.

The drone user may press the encrypted type information acquisition button 1215 to acquire the encrypted type information from the drone. The touch panel display screen 1210 has the user information input area 1211 where the user can input necessary information. When the user, after completing the input, presses the transmission button for certification authority 1212, the encrypted type information and the device authentication necessary information can be transmitted to the certification authority server 1100.

When aircraft authentication is successful, the certification authority server 1100 transmits an aircraft authentication passing certificate to the communication device 1200. The communication device 1200 receives the aircraft authentication passing certificate. When the reception is completed, the certificate reception display area 1213 of the panel display screen 1210 appears. The drone user then presses the transmission button for drone 1214. This allows the communication device 1200 to transmit the received aircraft authentication passing certificate to the drone 1000.

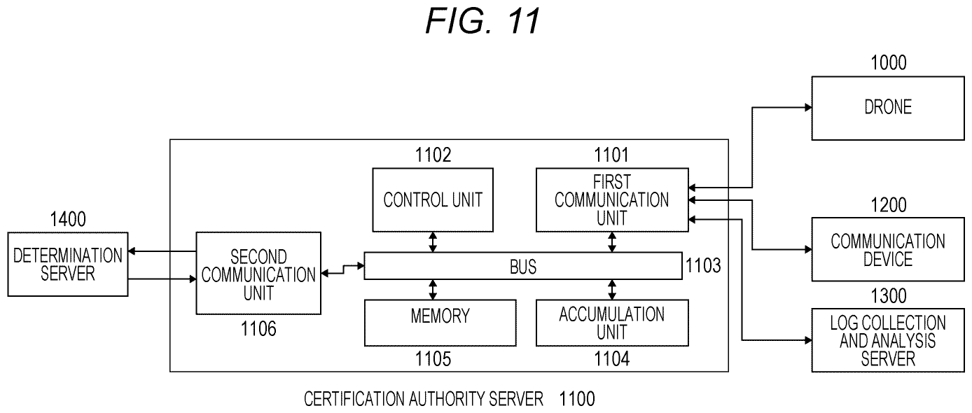

FIG. 11 is a diagram illustrating an example of the hardware configuration of the certification authority server 1100. The certification authority server 1100 includes a first communication unit 1101, a CPU 1102, a bus 1103, an accumulation unit 1104, a memory 1105, and a second communication unit 1106. The first communication unit 1101 is a device for communicating with external devices by wired or wireless communication, and is connected to the drone 1000, the communication device 1200, and the log collection and analysis server 1300. The second communication unit 1106 is a device for communicating with external devices by wired or wireless communication, and is connected to the determination server 1400 and acquires determination results of type authentication and device authentication. The first communication unit 1101 and the second communication unit 1106 may be the same in terms of hardware. The processing required for type authentication, aircraft authentication, and the like is performed by the CPU 1102 executing the program codes in the memory 1105. The functions of the bus 1103 and the accumulation unit 1104 are the same as those of communication device 1200. The log collection and analysis server 1300, the determination server 1400, and the auxiliary function server 7000 may also have the same hardware configuration as that of the certification authority server 1100.

Although the above embodiments are described as examples of a system for type authentication and aircraft authentication of the drone 1000, the present technology is not limited to such examples. For example, the above-described system may be used for authentication regarding unmanned vehicles such as unmanned ground vehicles (UGV), unmanned ships, and the like. Naturally, the above-described system can also be applied to manned vehicles.

Furthermore, authentication results acquired through type authentication and aircraft authentication, as well as various kinds of data acquired in conjunction with authentication can also be provided to third parties. For example, such results and various kinds of data may be shared with insurance companies, leasing companies, management companies, maintenance companies, and the like as appropriate. This enables more appropriate service, maintenance, and the like to be performed on the aircraft that is the target of authentication. Based on the authentication results acquired by aircraft authentication and various kinds of data acquired in conjunction with the authentication, control related to flight of a drone such as the flyable area of the drone and the maximum cruising time, as well as control for flight restrictions may be performed. This enables monitoring and management of the drone in accordance with the contents of authentication.

The above-described embodiments are illustrative purpose only for facilitating understanding of the present disclosure and are not intended to limit the present disclosure. It is to be understood that various changes and modifications can be made on the present disclosure without departing from the spirit thereof, and that the present disclosure includes the equivalents thereof.

Note that the following technology is also an example of the present technology.
(1) A type authentication system in which a drone including a component list, a certificate memory, and a communication module is connected to a certification authority server; a determination server determines pass/fail of type authentication based on check information on regulations related to type authentication transmitted from the drone and information on structural components of the drone written in the component list; and the certification authority server records a type authentication passing certificate in the certificate memory of the drone in accordance with a pass/fail result made by the determination server.
(2) The type authentication system in which the type authentication passing certificate is generated by adding information regarding an issuer of the certificate to information for identifying the drone, such as a model number and serial number transmitted from the drone, and combining encrypted type information encrypted using a public key of the certification authority server with the public key of the certification authority server.
(3) An aircraft authentication system in which a drone including a log accumulation unit, a plurality of certificate memories, and a communication module is connected to a communication device; information necessary for aircraft authentication is input to the communication device; and, based on a first pass/fail determination made by a determination server to check the information necessary for aircraft authentication and a result of analysis on log data accumulated in the log accumulation unit of the drone analyzed by a log collection and analysis server connected to the drone, the determination server determines pass/fail of aircraft authentication according to a second pass/fail determination for checking the log analysis result and the results of the first and second pass/fail determinations made by the determination server.
(4) An aircraft authentication system in which a drone including a plurality of certificate memories is connected to a communication device, information necessary for aircraft authentication is input to the communication device, and a certification authority server connected to the communication device: generates aircraft information by adding information on an issuer of a certificate to the input information necessary for aircraft authentication; creates an aircraft authentication passing certificate by performing encryption using a secret key of the certification authority server; and at a time of recording it on the certificate memories of the drone, decrypts a pass/fail result made by a determination server and encrypted type information encrypted using a public key of the certification authority server recorded on the certificate memory of the drone in type authentication using a secret key of the certification server and then collates a type authentication list indicating passing type authentication to determine pass/fail of the aircraft authentication based on the result confirming that the drone is qualified for the type authentication.
(5) The aircraft authentication system in which the information necessary for aircraft authentication indicates information that can identify a user of the drone, such as the name, address, and drone operation license information of the user of the drone.
(6) An aircraft authentication system in which a drone and a log collection and analysis server are connected to each other; an aircraft authentication passing certificate of the drone is acquired along with periodically collected log data; and the aircraft authentication passing certificate of the drone in the log collection and analysis server is collated with a certificate revocation list to revoke the aircraft authentication passing certificate of the drone.
(7) A type authentication and aircraft authentication system in which an expiration date written on a type authentication passing certificate and an expiration date written on an aircraft authentication passing certificate are compared with an expiration date timer of a drone or an expiration date timer of a log collection and analysis server, and a certificate that is over the expiration data is revoked.
(8) An aircraft authentication system in which aircraft information written on an aircraft authentication passing certificate and aircraft information encrypted using a secret key of a certification authority server written on the aircraft authentication passing certificate, which are recorded on a drone, are decrypted using a public key of the certification authority server written on a type authentication passing certificate; and the decrypted aircraft information is compared with the aircraft information written on the aircraft authentication passing certificate to determine whether to allow flight.
(9) An encryption system in which a pass/fail determination for type authentication and aircraft authentication is performed using results of visual checks on each unit of a drone, past log data accumulated in the past, and a certificate revocation list input in real time as auxiliary information.

The following technology is also an example of the present technology.

### (Item 1)

An authentication method related to authentication of an aerial vehicle performed by one or more information processing devices, the authentication method including:
acquiring type information of the aerial vehicle;
determining pass/fail of type authentication based on the type information;
encrypting type authentication information regarding type authentication of the aerial vehicle determined to be qualified using a prescribed public key; and
transmitting a type authentication passing certificate containing encrypted type information being encrypted along with the prescribed public key to the aerial vehicle to be stored in the aerial vehicle.

### (Item 2)

The authentication method according to item 1, in which
the type information includes information regarding a regulation checklist, and
pass/fail of the type authentication is determined based on the information regarding the regulation checklist.

### (Item 3)

The authentication method according to item 1 or 2, in which
the type information includes information regarding types of components configuring the aerial vehicle, and
pass/fail of the type authentication is determined based on the information regarding the types of the components configuring the aerial vehicle and information regarding types of components defined in a prescribed regulation.

### (Item 4)

The authentication method according to any one of items 1 to 3, the authentication method including:
acquiring the encrypted type information of the aerial vehicle and aircraft authentication necessary information that is necessary for aircraft authentication;
determining pass/fail of aircraft authentication of the aerial vehicle based on the aircraft authentication necessary information;
generating, based on the aircraft authentication necessary information, aircraft information of the aerial vehicle that is determined to be qualified;
encrypting the aircraft information based on a prescribed secret key that corresponds encrypting the aircraft information to the prescribed public key, and generating an aircraft authentication passing certificate including encrypted aircraft information obtained by the encrypting;
acquiring the encrypted type information from the aerial vehicle, and decrypting the encrypted type information using the prescribed secret key; and
making comparison of type information stored at determining pass/fail of the type authentication with the decrypted type information, and transmitting the aircraft authentication passing certificate to the aerial vehicle based on a result of the comparison to be stored.

### (Item 5)

The authentication method according to item 4, in which the aircraft authentication necessary information includes information regarding the aerial vehicle based on a user, and is information acquired by input through a device different from the aerial vehicle.

### (Item 6)

The authentication method according to item 4 or 5, including:
further acquiring log information accumulated regarding the aerial vehicle; and
performing analysis of the log information, and determining pass/fail of the aircraft authentication of the aerial vehicle based on an analysis result.

### (Item 7)

The authentication method according to item 6, in which the log information further includes log information accumulated regarding another aerial vehicle different from the aerial vehicle.

### (Item 8)

The authentication method according to item 6 or 7, in which pass/fail of the aircraft authentication of the aerial vehicle is determined based on inspection data that is different from the log information and obtained by an inspection performed by an inspector of the aerial vehicle.

### (Item 9)

The authentication method according to any one of items 4 to 8, including:
acquiring information regarding a revoked aircraft authentication passing certificate; and
determining pass/fail of the aircraft authentication of the aerial vehicle based on the information regarding the revoked aircraft authentication passing certificate.

### (Item 10)

The authentication method according to item 9, in which the information regarding the revoked aircraft authentication passing certificate is updated by update processing from outside.

### (Item 11)

The authentication method according to any one of items 4 to 10, in which the aircraft authentication passing certificate further includes the aircraft information in plain text, and the aircraft authentication passing certificate is transmitted to and stored in the aerial vehicle.

### (Item 12)

A validity determination method for checking validity of the aircraft authentication passing certificate of the aerial vehicle authenticated by the authentication method according to item 11, the validity determination method including
determining validity of the aircraft authentication passing certificate by making comparison of information based on the aircraft information in plain text with information that is obtained by decrypting the encrypted aircraft information based on the prescribed public key stored in the aerial vehicle.

### (Item 13)

The validity determination method according to item 12, in which the validity of the aircraft authentication passing certificate is determined based on information regarding an expiration date of the aircraft authentication passing certificate included in the aircraft information in plain text.

### (Item 14)

An aerial vehicle control method for controlling an operation of the aerial vehicle based on a determination result on the validity of the aircraft authentication passing certificate obtained by using the validity determination method according to item 12 or 13.

### (Item 15)

An authentication system related to authentication of an aerial vehicle, the authentication system including:
a certification authority server; and
a determination server, in which
the determination server:
acquires type information of the aerial vehicle via the certification authority server; and
determines pass/fail of type authentication based on the type information, and notifies the certification authority server, and
the certification authority server:
encrypts type authentication information regarding the type authentication of the aerial vehicle determined to be qualified using a prescribed public key; and
generates a type authentication passing certificate containing encrypted type information being encrypted along with the prescribed public key and transmits the type authentication passing certificate to the aerial vehicle.

### (Item 16)

The authentication system according to item 15, in which
the determination server:
acquires, via the certification authority server, the encrypted type information of the aerial vehicle and aircraft authentication necessary information that is necessary for aircraft authentication; and
determines pass/fail of aircraft authentication of the aerial vehicle based on the aircraft authentication necessary information, and notifies the certification authority server, and
the certification authority server:
generates, based on the aircraft authentication necessary information, aircraft information of the aerial vehicle determined to be qualified;
encrypts the aircraft information based on a prescribed secret key that corresponds to the prescribed public key and is stored in the certification authority server, and generates an aircraft authentication passing certificate including encrypted aircraft information obtained by the encryption;
acquires the encrypted type information from the aerial vehicle, and decrypts the encrypted type information using the prescribed secret key; and
makes comparison of type information stored at determining pass/fail of the type authentication with the decrypted type information, and transmits the aircraft authentication passing certificate to the aerial vehicle based on a result of the comparison.

### (Item 17)

The authentication system according to item 16, in which
the aircraft authentication passing certificate further includes the aircraft information in plain text, and
the certification authority server transmits the aircraft information in plain text to the aerial vehicle.

### (Item 18)

An aerial vehicle control system for checking validity of the aircraft authentication passing certificate of the aerial vehicle authenticated by the authentication system according to item 17, in which
a processor of the aerial vehicle determines the validity of the aircraft authentication passing certificate by making comparison of information based on the aircraft information in plain text with information that is obtained by decrypting the encrypted aircraft information based on the prescribed public key stored in the aerial vehicle.

### (Item 19)

The aerial vehicle control system according to item 18, in which the processor of the aerial vehicle controls an operation of the aerial vehicle based on a determination result on the validity of the aircraft authentication passing certificate.

### REFERENCE SIGNS LIST

1000 Drone
1100 Certification authority server
1200 Communication device
1300 Log collection and analysis server
1400 Determination server

1. An authentication method related to authentication of an aerial vehicle performed by one or more information processing devices, the authentication method comprising:
acquiring type information of the aerial vehicle;
determining pass/fail of type authentication based on the type information;
encrypting type authentication information regarding type authentication of the aerial vehicle determined to be qualified using a prescribed public key; and
transmitting a type authentication passing certificate containing encrypted type information being encrypted along with the prescribed public key to the aerial vehicle to be stored in the aerial vehicle.

2. The authentication method according to claim 1, wherein
the type information includes information regarding a regulation checklist, and
pass/fail of the type authentication is determined based on the information regarding the regulation checklist.

3. The authentication method according to claim 1, wherein
the type information includes information regarding types of components configuring the aerial vehicle, and
pass/fail of the type authentication is determined based on the information regarding the types of the components configuring the aerial vehicle and information regarding types of components defined in a prescribed regulation.

4. The authentication method according to claim 1, the authentication method comprising:
acquiring the encrypted type information of the aerial vehicle and aircraft authentication necessary information that is necessary for aircraft authentication;
determining pass/fail of aircraft authentication of the aerial vehicle based on the aircraft authentication necessary information;
generating, based on the aircraft authentication necessary information, aircraft information of the aerial vehicle that is determined to be qualified;
encrypting the aircraft information based on a prescribed secret key that corresponds to the prescribed public key, and generating an aircraft authentication passing certificate including encrypted aircraft information obtained by the encrypting;
acquiring the encrypted type information from the aerial vehicle, and decrypting the encrypted type information using the prescribed secret key; and
making comparison of type information stored at determining pass/fail of the type authentication with the decrypted type information, and transmitting the aircraft authentication passing certificate to the aerial vehicle based on a result of the comparison to be stored.

5. The authentication method according to claim 4, wherein the aircraft authentication necessary information includes information regarding the aerial vehicle based on a user; and is information acquired by input through a device different from the aerial vehicle.

6. The authentication method according to claim 4, comprising:
further acquiring log information accumulated regarding the aerial vehicle; and
performing analysis of the log information, and determining pass/fail of the aircraft authentication of the aerial vehicle based on an analysis result.

7. The authentication method according to claim 6, wherein the log information further includes log information accumulated regarding another aerial vehicle different from the aerial vehicle.

8. The authentication method according to claim 6, wherein pass/fail of the aircraft authentication of the aerial vehicle is determined based on inspection data that is different from the log information and obtained by an inspection performed by an inspector of the aerial vehicle.

9. The authentication method according to claim 4, comprising:
acquiring information regarding a revoked aircraft authentication passing certificate; and
determining pass/fail of the aircraft authentication of the aerial vehicle based on the information regarding the revoked aircraft authentication passing certificate.

10. The authentication method according to claim 9, wherein the information regarding the revoked aircraft authentication passing certificate is updated by update processing from outside.

11. The authentication method according to claim 4, wherein the aircraft authentication passing certificate further includes the aircraft information in plain text, and the aircraft authentication passing certificate is transmitted to and stored in the aerial vehicle.

12. A validity determination method for checking validity of the aircraft authentication passing certificate of the aerial vehicle authenticated by the authentication method according to claim 11, the validity determination method comprising
determining validity of the aircraft authentication passing certificate by making comparison of information based on the aircraft information in plain text with information that is obtained by decrypting the encrypted aircraft information based on the prescribed public key stored in the aerial vehicle.

13. The validity determination method according to claim 12, wherein the validity of the aircraft authentication passing certificate is determined based on information regarding an expiration date of the aircraft authentication passing certificate included in the aircraft information in plain text.

14. An aerial vehicle control method for controlling an operation of the aerial vehicle based on a determination result on the validity of the aircraft authentication passing certificate obtained using the validity determination method according to claim 12.

15. An authentication system related to authentication of an aerial vehicle, the authentication system including:
a certification authority server; and
a determination server, in which
the determination server:
acquires type information of the aerial vehicle via the certification authority server; and
determines pass/fail of type authentication based on the type information, and notifies the certification authority server, and
the certification authority server:
encrypts type authentication information regarding the type authentication of the aerial vehicle determined to be qualified using a prescribed public key; and
generates a type authentication passing certificate containing encrypted type information being encrypted along with the prescribed public key and transmits the type authentication passing certificate to the aerial vehicle.

16. The authentication system according to claim 15, wherein
the determination server:
acquires, via the certification authority server, the encrypted type information of the aerial vehicle and aircraft authentication necessary information that is necessary for aircraft authentication; and
determines pass/fail of aircraft authentication of the aerial vehicle based on the aircraft authentication necessary information, and notifies the certification authority server, and
the certification authority server:
generates, based on the aircraft authentication necessary information, aircraft information of the aerial vehicle determined to be qualified;
encrypts the aircraft information based on a prescribed secret key that corresponds to the prescribed public key and is stored in the certification authority server, and generates an aircraft authentication passing certificate including encrypted aircraft information obtained by the encryption;
acquires the encrypted type information from the aerial vehicle, and decrypts the encrypted type information using the prescribed secret key; and
makes comparison of type information stored at determining pass/fail of the type authentication with the decrypted type information, and transmits the aircraft authentication passing certificate to the aerial vehicle based on a result of the comparison.

17. The authentication system according to claim 16, wherein
the aircraft authentication passing certificate further includes the aircraft information in plain text, and
the certification authority server transmits the aircraft information in plain text to the aerial vehicle.

18. An aerial vehicle control system for checking validity of the aircraft authentication passing certificate of the aerial vehicle authenticated by the authentication system according to claim 17, wherein
a processor of the aerial vehicle determines the validity of the aircraft authentication passing certificate by making comparison of information based on the aircraft information in plain text with information that is obtained by decrypting the encrypted aircraft information based on the prescribed public key stored in the aerial vehicle.

19. The aerial vehicle control system according to claim 18, wherein the processor of the aerial vehicle controls an operation of the aerial vehicle based on a determination result on the validity of the aircraft authentication passing certificate.
